(19) United States
(12) Patent Application Publication
(10) Pub. No.: US 2009/0214053 A1
(43) Pub. Date: Aug. 27, 2009

(54) POSITION DETERMINATION OF SOUND SOURCES

(76) Inventor: Friedrich Reining, Vienna (AT)

Correspondence Address: HARMAN - BRINKS HOFER CHICAGO;Brinks Hofer Gilson & Lione, P.O. Box 10395, Chicago, IL, 60610, US

(21) Appl. No.: 12/391,030

(22) Filed: Feb. 23, 2009

(30) Foreign Application Priority Data
Nov. 13, 2007 (AT) PCT/AT2007/000511

(51) Int. Cl. H04R 3/00

(52) U.S. Cl. 381/92

(57) ABSTRACT

A microphone arrangement includes a database and multiple pressure gradient transducers having a diaphragm, a first sound inlet opening, and a second sound inlet opening. A directional characteristic of each of the pressure gradient transducers have a direction of maximum sensitivity in main directions. The main directions of the pressure gradient transducers are inclined. A pressure transducer has an acoustic center lying within an imaginary sphere with multiple acoustic centers of the pressure gradient transducer. The imaginary sphere has a radius corresponding to about double the largest dimension of the diaphragms of the pressure gradient transducers and the pressure transducer. The database retains representative signals of the multiple pressure gradient transducers and the pressure transducer. A processor accesses the database to determine a position of a sound source.

### PRIORITY CLAIM

This application claims the benefit of priority from PCT/AT2007/000511, filed Nov. 13, 2007, which is incorporated by reference.

### BACKGROUND OF THE INVENTION

1. Technical Field

This disclosure relates to determining the position and direction of a sound source.

2. Related Art

The ability to detect sound in distance and direction may improve audibility and intelligibility. It may allow systems to track sources as they move from one position to another.

Some systems process time delays to track the position of sound sources. These systems may require devices of very large dimensions. When not spaced apart correctly, the systems may not detect low frequency phase differences.

### SUMMARY

A microphone arrangement includes a database and multiple pressure gradient transducers having a diaphragm, a first sound inlet opening, and a second sound inlet opening. A directional characteristic of each of the pressure gradient transducers have a direction of maximum sensitivity in main directions. The main directions of the pressure gradient transducers are inclined. A pressure transducer has an acoustic center lying within an imaginary sphere with multiple acoustic centers of the pressure gradient transducer. The imaginary sphere has a radius corresponding to about double the largest dimension of the diaphragms of the pressure gradient transducers and the pressure transducer. The database retains representative signals of the multiple pressure gradient transducers and the pressure transducer. A processor accesses the database to determine a position of a sound source.

Other systems, methods, features, and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows the transition between a far-field and a near-field as a function of distance and frequency.

FIG. 2 shows the sound velocity levels as a function of frequency for different distances from a sound source.

FIG. 3 shows a gradient transducer with sound inlet openings on opposite sides of a capsule housing.

FIG. 4 shows a gradient transducer with sound inlet openings on a common side of the capsule housing.

FIG. 5 shows a pressure transducer in cross-section.

FIG. 6 is a microphone arrangement in a plane.

FIG. 7 shows the pickup patterns of the individual transducers of FIG. 6.

FIG. 8 is a microphone arrangement supported by a curved surface.

FIG. 9 shows transducers in a common housing.

FIG. 10 is a transducer arrangement embedded in an interface.

FIG. 11 is a transducer arrangement arranged on the interface.

FIG. 12 is a microphone arrangement comprising gradient transducers and a pressure transducer.

FIG. 13 shows an arrangement that includes four gradient transducers and four pressure transducers.

FIG. 14 is a schematic of a coincidence condition.

FIG. 15 shows an arrangement of two gradient transducers having a hypercardioid-like characteristics and a pressure transducer.

FIG. 16 is a measurement arrangement of a transducer.

FIG. 17 is signal process logic programmed to determine spatial coordinates.

FIG. 18 shows stored families of curves and a measure curve.

### DETAILED DESCRIPTION OF THE PREFERRED EMBODIMENTS

A system may accurately determine direction and distance from a sound source, without processing time delays. The system may reliably and quickly identify attributes ascribed to a source across a large frequency range. The system may include a pressure transducer and pressure gradient transducer. The acoustic centers of the pressure gradient transducers and the pressure transducer may be within an imaginary sphere having a radius corresponding to about double of the largest dimension of the diaphragm of a transducer. The arrangement ensures a coincident position of all transducers. In an alternative system, the acoustic centers of the pressure gradient transducers and the pressure transducer may lie within an imaginary sphere having a radius corresponding to the largest dimension of the diaphragm of a transducer. Coincidence may increase by moving the sound inlet openings together.

The position of a sound source may be identified by a transducer arrangement that includes one pressure transducer, or a zero-order transducer, and at least two gradient transducers. The main directions of the gradient transducers may be sloped relative to each other. The pressure transducers and gradient transducers may be positioned close together like a coincident arrangement.

In some systems, the outputs of the transducers are compared against a plurality of stored signals retained in a database. Each stored signal corresponds to a transducer and may be coded with position information in relation to the microphone arrangement. The identification of a position of a sound source may be based on the level of matching between an actual signal and a stored signal.

The near-field effect or proximity effect may be exploited. This effect may occur in gradient transducers and causes an increase detection of low frequencies, if a sound source is positioned in the vicinity of the gradient transducer. An overemphasis of low frequencies may become stronger, the closer the sound source and gradient transducer are to each other. The near-field effect may occur at a microphone spacing that is smaller than the wavelength λ of the considered frequency.

Logically (e.g., encoded in software stored on a computer readable storage media), the near-field effect may be explained by differences in the transducer concept. In a flat sound field, the sound pressure and sound are always in phase, so that there is one near-field effect for a flat sound field. In a spherical sound source, a distinction is made between sound pressure and sound velocity. The amplitude of the sound pressure diminishes in a spherical sound source with 1/r (in which r denotes the distance from an omni sound source), so that in a pressure transducer (or a zero-order transducer), no near-field effect may occur. The sound velocity of the omni sound source is obtained from two terms:

$$\begin{matrix}{v}_{r , Far - field} = \frac{1}{ρ * c} * \frac{A}{r} cos [ k ( ct - r ) + {ϕ}_{A} ] & ( 1 ) \\ {V}_{r , Near - field} = \frac{1}{ρ * c} * \frac{A}{{kr}^{2}} sin [ k ( ct - r ) + {ϕ}_{A} ] & ( 2 )\end{matrix}$$

In which:

### ρ . . . Density

r . . . Distance from the sound source
c . . . Sound velocity

### λ . . . Wavelength

### t . . . Time

φ_{A} . . . Phase

k . . . Circular wave number (2π/λ or. 2πf/c)

### A . . . Amplitude

### f . . . Frequency

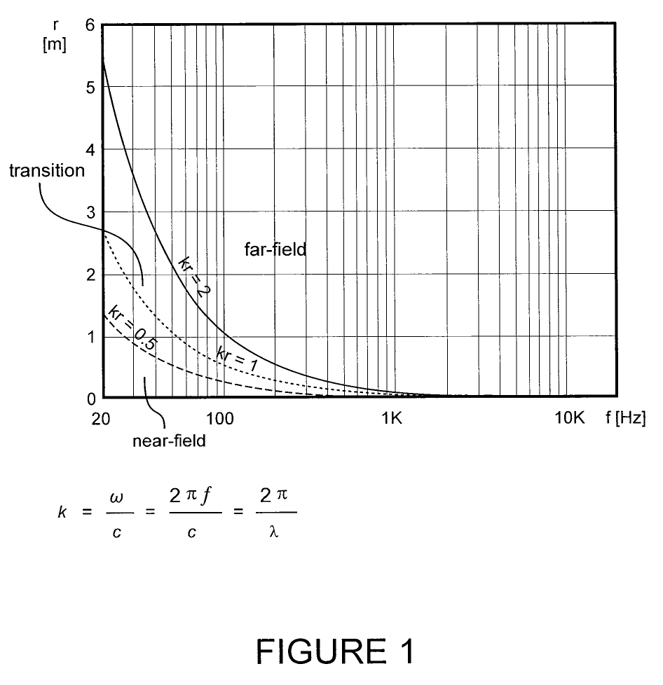

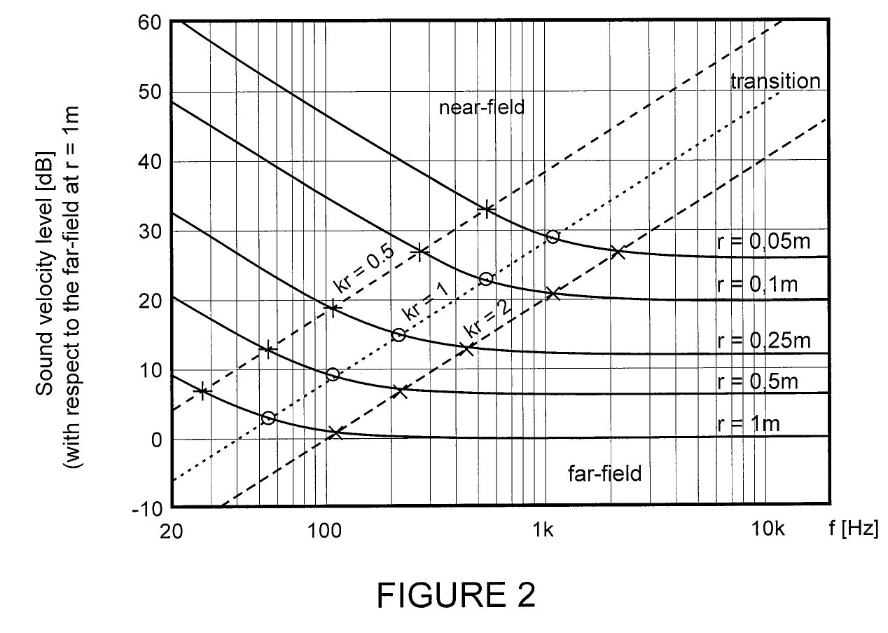

In formulas (1) and (2), the sound velocity diminishes in the far-field of 1/r, but in the near-field with 1/(k×r²). The increase of signal level pickup with a pressure gradient microphone as a function of distance and frequency is shown in FIGS. 1 and 2. The separation between the near and far-field is described by k×r=1, the transitional areas between the near and far-field are limited by k×r=2 and k×r=0.5.

The characteristics of each individual gradient capsule may also be described by the formula:

$$K = \frac{1}{a + b} ( a + b cos ( θ ) ) \qquad ( 1 )$$

in which a represents the weighting factor of the omni fraction and b the weighting factor for the gradient fraction. For values a=1, b=1, a cardioid may be obtained, for values a=1 and b=3, a hypercardioid may be obtained.

The boost factor B of a gradient microphone may be described by the proximity effect as a function of angle of incidence on the gradient microphone. This relationship described in “On the Theory of the Second-Order Sound Field Microphone” by Philip S. Cotterell, BSc, MSc, AMIEE, Department of Cybernetics, February 2002, which is incorporated by reference, is:

$$B = \frac{1}{a + b} \frac{\sqrt{\begin{matrix}{b}^{2} {cos}^{2} ( θ ) {cos}^{2} ( Φ ) + {k}^{2} {r}^{2} \\ {( a + b cos ( θ ) cos ( Φ ) )}^{2}\end{matrix}}}{kr} \qquad ( 3 )$$

The angle θ may stand for the azimuth of the omni coordinates and φ for the elevation. For the simple case of a cardioid (a=1, b=1), the boost factor B at large values of (k×r), (e.g., at large distance r and high frequency f), may comprise

$$B = \frac{1}{2} \frac{\sqrt{1 + 4 {k}^{2} {r}^{2}}}{kr} \qquad ( 4 )$$

This expression tends toward the value 1 for increasing (k×r).

At small values of (k×r), the following expression may be obtained for the boost factor B

$$B = \frac{1}{2 kr} \qquad ( 5 )$$

Smaller values of (k×r) lead to a successive increase in level.

If an azimuthal angle θ of 180° is inserted in formula (3), the same expression as in formula (5) may be obtained for the boost factor B. This means that the near-field effect has a type of figure-eight characteristic (for an azimuthal angle θ of 90°, the dependence on k×r disappears).

The near-field effect occurs in pressure gradient transducers, (e.g., it occurs in directed microphones, but not in pressure transducers) and is dependent on the angle of incidence of the sound with reference to the main direction of the sound receiver. In the main direction, for example, of a cardioid or hypercardioid, the near-field effect is most strongly pronounced, whereas it is substantially negligible from the direction slope by about 90° to it. The near-field effect may be processed, to determine the distance between the coincident transducer arrangement and sound source. Since the omni signal generated by the pressure transducer is not influenced by a proximity effect, comparison between the gradient signal and the omni signal permits determination of the distance to the sound source.

Distance measures may occur by comparing the individual transducer signals or signals derived from them with stored datasets (e.g., in a local or remote database) that are coded with a certain distance or direction. Datasets may be generated by exposing the transducer arrangement to sound originating from a number of points in an area (e.g., a room), which have different directions and distances from the coincident transducer arrangement, using a test pulse of a test sound source.

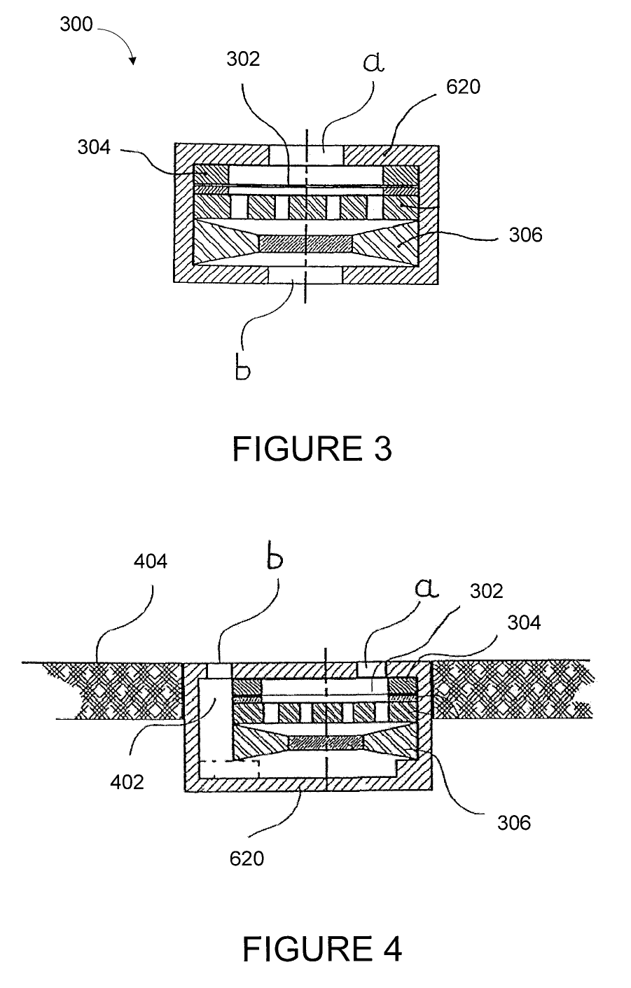

Examples of transducer arrangements are further shown in FIGS. 3 to 5. FIG. 3 and FIG. 4 show the difference between a “normal” gradient capsule and a “flat” gradient capsule. In FIG. 3, a sound inlet opening a is positioned on the front of the capsule housing 300 and a second sound inlet opening b on the opposite back side of capsule housing 300. The front sound inlet opening a is connected to the front of diaphragm 302, which is tightened on a diaphragm ring 304, and the back sound inlet opening b is connected to the back of diaphragm 302.

For pressure gradients, it applies that the front of the diaphragm is the side that may be reached relatively unhampered by the sound. The back of the diaphragm may be reached (e.g., only reached) by the sound after it passes through an acoustically phase-rotating element. The sound path to the front is shorter than the sound path to the back and the sound path to the back has high acoustic friction. In the area behind electrode 7 or where the acoustic friction device 8 is situated the acoustic friction may form a constriction from a non-woven element, foam element, or other material.

In the flat gradient capsule of FIG. 4, (or interface microphone) both sound inlet openings a, and b are positioned on the front of capsule housing 300. One inlet leads to the front of the diaphragm 302 and the other to the back of diaphragm 302 through a sound channel 402. This converter may be incorporated in an interface 404, for example, within a console of a vehicle, etc. The acoustic friction devices 306 or non-woven devices, foam, constrictions, perforated devices, plates, etc., may be arranged in the area next to diaphragm 302. A very flat (or substantially flat) design may be used.

In arrangements with sound inlet openings a and b positioned on one side of a capsule, an asymmetric pickup pattern relative to the diaphragm axis may occur. Cardioid, hypercardioid, etc. patterns may occur. Other patterns including those described in EP 1 351 549 A2 or U.S. Pat. No. 6,885,751 A, which are incorporated by reference, may be generated.

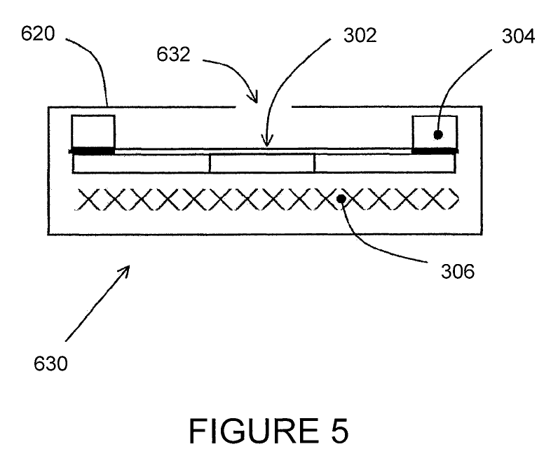

A pressure transducer, or zero-order transducer, is shown in FIG. 5. In this figure, only the front of the diaphragm is directly exposed to the surroundings. The back faces a closed volume. In some arrangements, small openings pass into the rear volume, to compensate for static pressure changes. In this alternative, passages to the volume have little or no effect on the dynamic properties and pickup pattern. Pressure transducers may have an omni pickup pattern. Slight deviations may occur with changes in frequency.

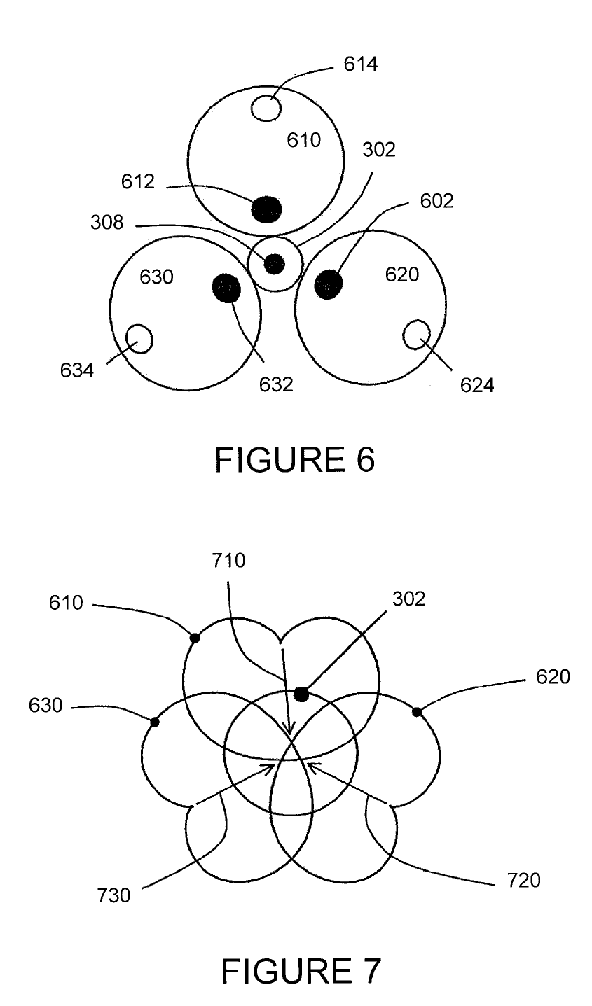

FIG. 6 shows a microphone arrangement that includes three pressure gradient transducers 610, 620, 630 and a pressure transducer 302 enclosed by the pressure gradient transducers. The pickup pattern of the pressure gradient transducers of FIG. 7 includes an omni portion and a figure-eight portion. This pickup pattern may be represented as P(θ)=k+(1−k)×cos(θ), in which k denotes the angle-independent omni fraction and (1−k)×cos(θ) the angle-dependent figure-eight portion. An alternative mathematical description of the pickup pattern, which also accounts for normalization, is described by equation (1). As shown in the directional distribution of the individual transducers of FIG. 7, the gradient transducer may be positioned to generate a cardioid characteristic. In alternative arrangements, gradients may result in a combination of sphere and figure-eight like shapes (e.g., like hypercardioids).

The pickup pattern of a pressure transducer 302 may comprise an omni. Deviations from an omni form may occur at higher frequencies due to tolerances and quality variations. The pick-up pattern may also be described approximately by a sphere like shape. Unlike a gradient transducer, a pressure transducer may have one sound inlet opening. The deflection of the diaphragm may be proportional to pressure and not dependent on a pressure gradient between the front and back of the diaphragm.

The gradient transducers 610, 620, and 630 may lie in an x-y plane and may be distributed almost uniformly about the periphery of an imaginary circle, (e.g., they may have essentially the same spacing relative to each other). In a three gradient transducer arrangement, the main directions 710, 720, 730 (the directions of maximum sensitivity) may be sloped relative to each other by an azimuthal angle of about 120° (FIG. 7). In n gradient transducers, the angle between main directions lying in a plane is 360°/n. Deviations of a few degrees may occur.

Any type of gradient transducer may be used in the disclosed arrangements. The illustrated arrangements provide good performance through a flat transducer or interface microphone, in which the two sound inlet openings lie on a common surface such as a side surface or interface.

In FIG. 6, the converters 610, 620, 630, 302 are arranged in coincidence with each other. The converters oriented relative to each other, so that the sound inlet openings 612, 622, 632, 308, which lead to the front of the corresponding diaphragm, lie as close as possible to each other. The sound inlet opening 614, 624, 634 of the gradient transducers, which lead to the back of the diaphragm, lie on the periphery of the arrangement. The intersection of the lengthened connection lines, which connect the front sound inlet opening 612, 622, 632 to the rear sound inlet opening 614,624, 634 may be viewed as the center of the microphone arrangement. The pressure transducer 302 lies near or in the center of this arrangement. FIG. 7, shows the center in which the main directions 710, 720, 730 of the gradient transducers are directed. The front sound inlet openings 612, 622, 632 of the transducers 610, 620 and 630, also called speak-ins, are positioned in the center area of the arrangement. Through this arrangement, coincidence of the converters may be strongly increased. The pressure transducer 302 is situated in a center area of the microphone arrangement. The single sound inlet opening of pressure transducer 302 may be positioned at the intersection of the connection lines of the sound inlet openings of the pressure gradient transducers 610, 620, 630.

Coincidence may occur because the acoustic centers of the gradient transducers 610, 620, 630 and the pressure transducer 302 lie together (e.g., as close as possible), preferably at or near a common point or area. The acoustic center of a reciprocal transducer occurs at the point from which omni waves seem to be diverging when the transducer is acting as a source. “A note on the concept of acoustic center”, by Jacobsen, Finn; Barrera Figueroa, Salvador; Rasmussen, Knud; Acoustical Society of America Journal, Volume 115, Issue 4, pp. 1468-1473 (2004), which is incorporated by references, examines methods of determining the acoustic center of a source, including methods based on deviations from the inverse distance law and methods based on the phase response. The considerations are illustrated by experimental results for condenser microphones.

The acoustic center may be determined by measuring omni wave fronts during sinusoidal excitation of the acoustic transducer. The measurement may occur at a selected frequency at a selected direction and at a selected distance from the converter in a small spatial area, the observation point. Starting from the information about the omni wave fronts, information may be gathered about the center of the omni wave, the acoustic center.

“The acoustic center of laboratory standard microphones” by Salvador Barrera-Figueroa and Knud Rasmussen; The Journal of the Acoustical Society of America, Volume 120, Issue 5, pp. 2668-2675 (2006), which is incorporated by reference, provides information about acoustic centers. For a reciprocal transducer, like the condenser microphone, it may not matter whether the transducer is operated as a sound transmitter or a sound receiver. The acoustic center may be determined by the inverse distance law:

$$p ( r ) = j \frac{ρ * f}{2 * {r}_{t}} {M}_{f} * i * {e}^{- γ * {r}_{1}} \qquad ( 6 )$$

rₜ . . . acoustic center
ρ . . . density of the air
f . . . frequency
M_{f} . . . microphone sensitivity
i . . . current
y . . . complex wave propagation coefficient

In pressure receivers, the center may comprise average frequencies (in the range of 1 kHz) that may deviate at high frequencies. The acoustic center may occur in a small region. The acoustic center of gradient transducers may be identified by a different approach, since formula (6) does not consider near-field-specific dependences. The location of an acoustic center may also be identified by locating the point in which a transducer must be rotated, to observe the same phase of the wave front at the observation point.

In the gradient transducer, an acoustic center may be identified through a rotational symmetry. The acoustic center may be situated on a line normal (or substantially normal) to the plane of the diaphragm. The center point on any line may be determined by two measurements, at a point most favorable from the main direction of about 0°, and from a point of about 180°. In addition to comparisons of phase responses of these two measurements, which determine a frequency-dependent acoustic center, an average estimate of the acoustic center may change the rotation point. The rotation point is the point around which the transducer is rotated between the measurement, so that the impulse responses maximally overlap (e.g., so that the maximum correlation between the two impulse responses lies in the center).

In “flat” gradient capsules, in which two sound inlet openings are positioned on an interface, the acoustic center may not be the center of the diaphragm. The acoustic center may lie closest to the sound inlet opening that leads to the front of the diaphragm. This forms the shortest connection between the interface and the diaphragm. In other arrangements, the acoustic center lies outside the capsule.

When using an additional pressure transducer, separation should be considered. If one considers the diaphragm of a pressure transducer in the XY plane and designates the angle that an arbitrary in the XY plane encloses with the X axis as azimuth, and the angle that an arbitrary direction encloses the XY plane as an elevation, the following may be practiced. The deviation of the pressure transducer signal from the ideal omni signal may become greater with increasing frequency (for example, above 1 kHz), but increases much more strongly during sound exposure from different elevations.

Because of these considerations, an alternative is obtained when the pressure transducer is arranged on an interface, so that the diaphragm is substantially parallel to the interface. In an alternative, the diaphragm lies as close as possible to the interface, preferably flush with it, but at least within a distance that corresponds to the maximum dimension of the diaphragm. The acoustic center for such a layout lies on a line substantially normal to the diaphragm surface at or near the center of the diaphragm. With good approximation, the acoustic center may lie on the diaphragm surface in the center of the diaphragm.

The coincidence criterion may require, that the acoustic centers 1410, 1420, 1430, 1402 of the pressure gradient capsules 610, 620, 630 and the pressure transducer 302 lie within an imaginary sphere O, whose radius R is double (or about double) the largest dimension D of the diaphragm of a transducer. In an alternative system the acoustic centers of the pressure gradient transducers and the pressure transducer may lie within an imaginary sphere whose radius corresponds to the largest dimension of the diaphragm of a transducer. By increasing the coincidence by moving sound inlet openings together, exceptional results may be achieved.

To ensure a coincidence condition in one exemplary arrangement, the acoustic centers 1410, 1420, 1430, 1402 of the pressure gradient capsules 610, 620, 630 and the pressure transducer 302 lie within an imaginary sphere O, having a radius R equal to the largest dimension D of the diaphragm of a transducer. The size and position of the diaphragms 1412, 1422, 1432, 1404, are indicated by dashed lines.

In an alternative, the coincidence condition may also be established, in that the first sound inlet openings 612, 622, 632 and the sound inlet opening 308 for pressure transducer 302 lie within an imaginary sphere O, whose radius R corresponds to the largest dimension D in diaphragm 1402, 1422, 1432, 1404 of the transducer. Since the size of the diaphragm may determine the noise distance and may represent the direct criterion for acoustic geometry, the largest diaphragm dimension D (for example, the diameter in a circular diaphragm, or a side length in a triangular or rectangular diaphragm) may determine the coincidence condition.

In some systems the diaphragms 1402, 1422, 1432, and 1404 do not have the same dimensions. In these systems, the largest diaphragm is used to determine the preferred criterion.

In FIG. 6, the transducers 610, 620, 630 and 302 are positioned in a plane. The connection lines of the individual transducers, which connect the front and rear sound inlet opening to each other, are sloped relative to each other by an angle of about 120°.

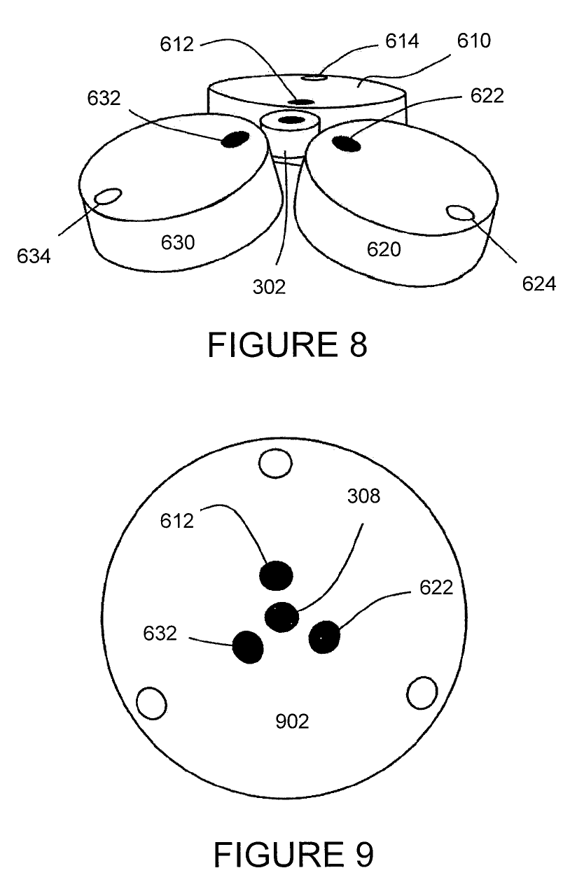

FIG. 8 shows two pressure gradient transducers 610, 620, 630 and the pressure transducer 302 are not arranged in a plane, but positioned on an imaginary omni surface. This may occur when the sound inlet openings of the microphone arrangement are arranged on a curved interface, for example, like a console of a vehicle. The interface, in which the transducers are embedded, or on which they are fastened, is not shown in FIG. 8.

In the curvature arrangement of FIG. 8, the distance to the center may be reduced (which is desirable, because the acoustic centers lie closer together), but the speak-in openings are somewhat shadowed. This may change the pickup pattern of the individual capsules, so that the figure-eight fraction of the signal becomes smaller (from a hypercardioid, a cardioid is then formed). To minimize the adverse affect of the curvature may be limited (e.g., not to exceed about 60°). The pressure gradient capsules 610, 620, 630 are placed on the outer surface of an imaginary cone, whose surface line encloses an angle of at least 30° with the cone axis.

The sound inlet openings 612, 622, 632 of the gradient transducers that lead to the front of the diaphragm lie in a plane, referred to as the base plane. The sound inlet openings 614, 624, 634 arranged on a curved interface lie outside of the base plane. The projections of the main directions of the gradient transducers 610, 620, 630 into the base plane enclose an angle that amounts to about 360°/n, in which n stands for the number of gradient transducers arranged in a circle.

Like the arrangement where the capsules are arranged in a plane, the main directions of the pressure gradient transducers are sloped relative to each other by an azimuthal angle φ (e.g., they are not only sloped relative to each other in a plane of the cone axis, but the projections of the main directions are sloped relative to each other in a plane normal to the cone axis).

In the arrangement of FIG. 8, the acoustic centers of the gradient transducers 610, 620, 630 and the pressure transducer 302 also lie within an imaginary sphere, whose radius is less than the largest dimension of the diaphragm of a transducer in the arrangement. By this spatial proximity of acoustic centers, coincidence is achieved. Like the alternative system of FIG. 6, the capsules depicted in FIG. 8 are arranged on an interface or embedded within it.

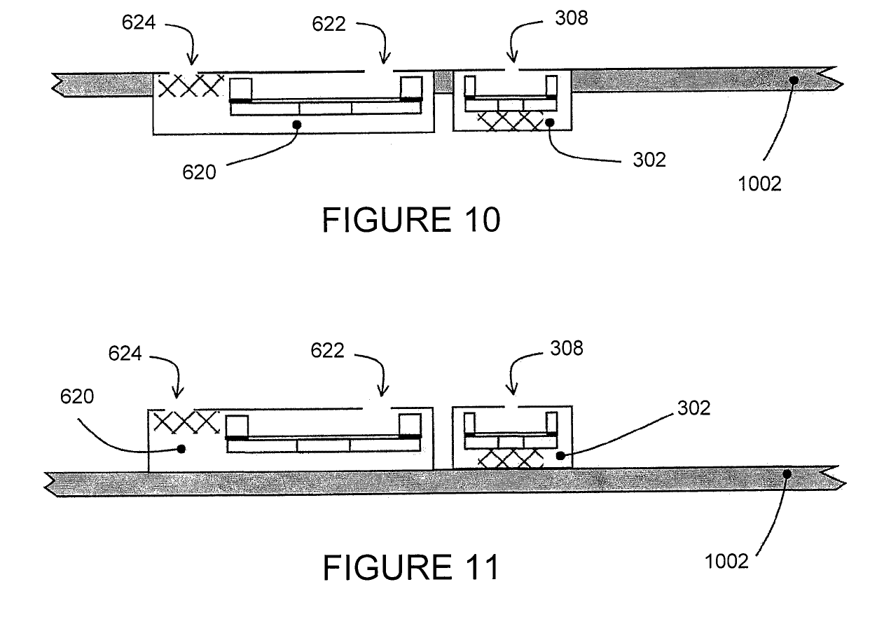

Capsule arrangements on an interface are shown in FIGS. 10 and 11. In FIG. 10, which shows a section through a microphone arrangement from FIG. 6, the capsules positioned on the interface 1002 or are fastened to it. In FIG. 11, they are embedded in interface 1002 and are flush with interface 1002 with their front sides.

In an alternative system, the pressure gradient capsules 610, 620, 630 and the pressure transducer 302 are arranged within a common housing 902, in which the diaphragms, electrodes and mounts of the individual transducers are separated from each other by partitions. The sound inlet openings may not be visible from an outside view in some systems. The surface of the common housing, in which the sound inlet openings are arranged, may be a plane (refer to the arrangement of FIG. 6) or a curved surface (refer to the arrangement of FIG. 8). The interface 20 may be a plate, console, wall, cladding, etc.

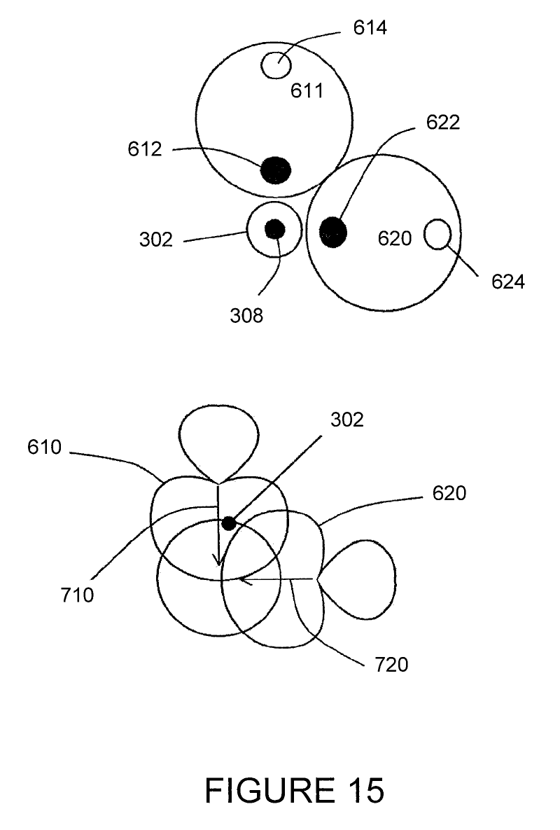

FIG. 15 shows an arrangement that includes pressure gradient transducers 610, 620 and a pressure transducer 302 that may be analyzed to determine an azimuth angle θ and distance r. In this system the pickup patterns of the gradient transducers are hypercardioids or shapes similar to hypercardioids. The microphones may receive distinctly pronounced signal fraction patterns in a direction of about 180° to the main direction 710, 720. An alternative arrangement positions the gradient transducers 610, 620 in an arrangement that renders the main directions 710, 720 substantially orthogonal to each other. Interpreting level differences due to the near-field effect may be ambiguous but phase differences may also be used to determine the azimuth angle and distance. The described coincidence condition may also apply to this arrangement.

In each of the transducer arrangements described above, a sound source may be localized with reference to the azimuthal angle θ and distance r from the transducer arrangement. A determination of elevation φ of a sound source in space may be further identified in other transducer arrangements.

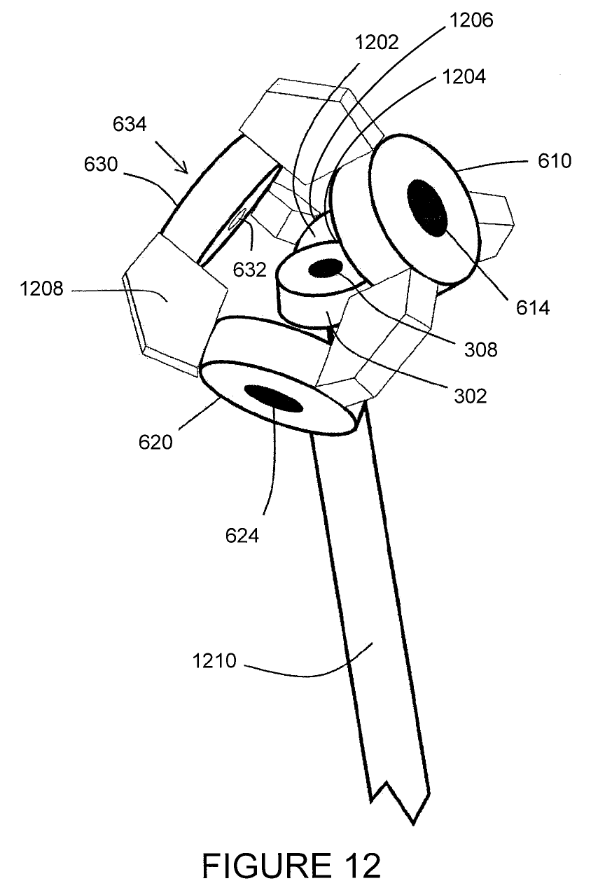

FIG. 12 shows an alternative that does not include a one-sided sound inlet microphone. In the alternate, four gradient transducers are used in spatial arrangement. In each of the pressure gradient transducers 610, 620, 630, 1202, the first sound inlet opening 612, 622, 632, 1204 is arranged on the front of the capsule housing, the second sound inlet opening 614, 624, 634, 1206, on the back of the capsule housing. The pressure transducer 302 has only sound inlet opening 308 passing through a front surface. The first sound inlet openings 612, 622, 632, 1204, lead to the front of the diaphragm and face each other. This arrangement satisfies coincidence criterion in that they lie within an imaginary sphere, whose radius corresponds to double of the largest dimension of the diaphragm in one of the transducers. The main directions of the gradient transducers face a common center area of the microphone arrangement.

Exemplary dimensions are shown in FIG. 12. Assume the spatial transducer arrangement comprises ideal flat transducers that coincide with the surface of a tetrahedron. A ratio is obtained from the maximum diameter D of the diaphragm surface to the radius R of the enclosing sphere:

$${R}_{Sphere} = {D}_{Membrane} * \frac{3}{4} \sqrt{2} ∼ 1.06$$

In some configurations, such a transducer arrangement may not be implemented with diaphragms extending to the edges of the tetrahedron, since the diaphragms may be mounted on a rigid ring and the individual capsules may not be made arbitrarily thin. However this issue may be overcome, if the transducer arrangement, particularly the sound inlet openings leading to the front of the diaphragm, lies within an imaginary sphere O, whose radius R is equal to double (or about double) the largest dimension D of the diaphragm of one of the transducers.

If, the gradient transducers, shown in FIG. 12, are arranged on the surfaces of an imaginary tetrahedron and are spaced from each other by spacers 1208, this arrangement creates space for the pressure transducer 302 in the center of the arrangement. The entire arrangement may be secured to a microphone rod or support 1210.

In FIG. 10, the coincident condition may appear to arrangements with four pressure gradient transducers or more. Four or more gradient transducers may be arranged to obtain a synthesized omni signal from their signals by sum formation.

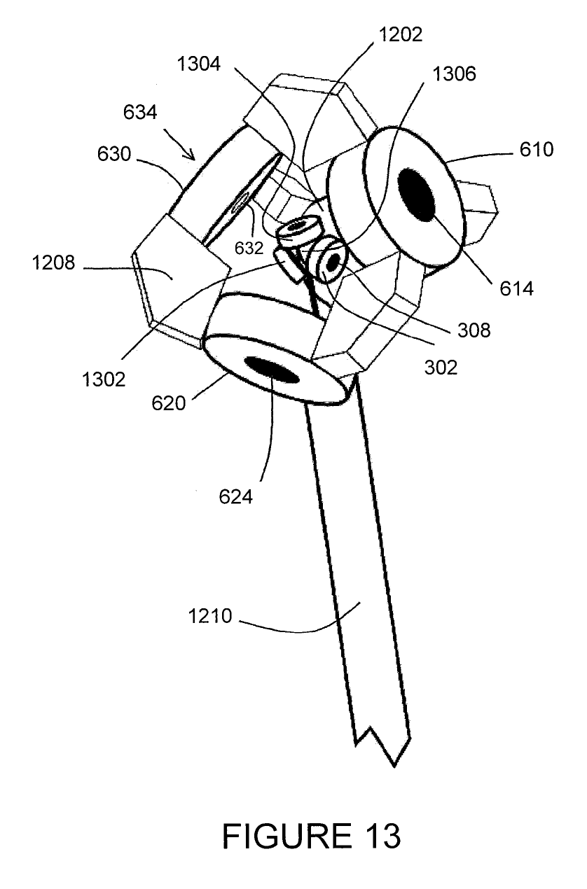

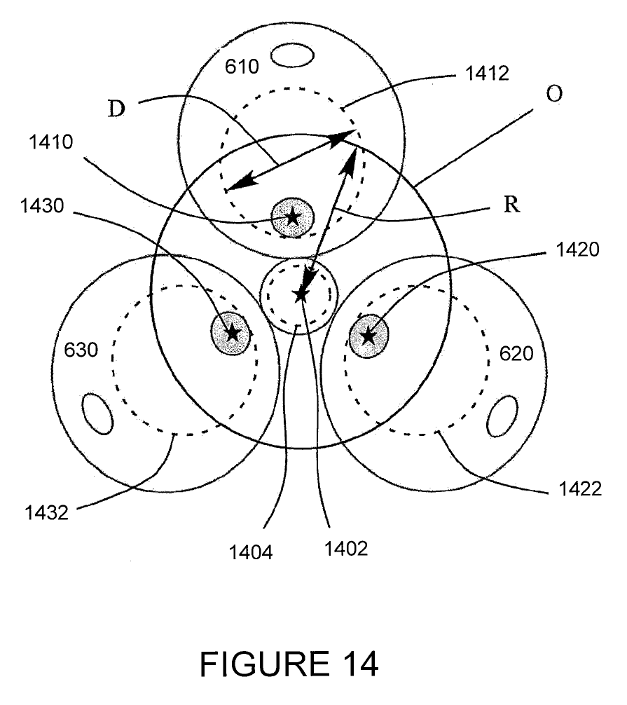

In FIG. 13, several pressure transducers 302, 1302, 1304, 1306, may also be positioned in an alternative system. By summation of the omni signals of the individual pressure transducers, an omni signal is formed that is still homogeneous in its approximation to an ideal sphere and is independent of frequency. In the present practical example, four pressure transducers 302, 1302-1306 are arranged on the surface of the tetrahedron. The sound inlet openings are directed outward. The spacers 1208 may be used to position the pressure transducers or gradient transducers. During signal processing, the individual gradient transducer signals may be related to the synthesized omni signal.

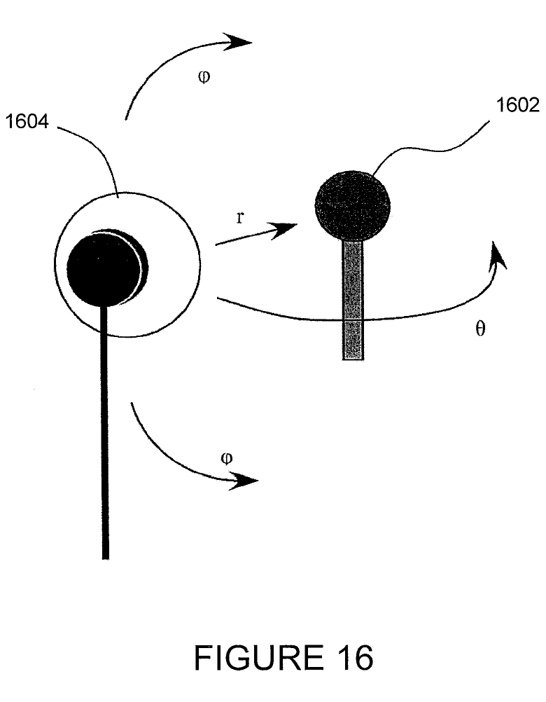

In some applications, a microphone may be measured. A measurement of a transducer arrangement 160 may include a loudspeaker 1604, which is positioned in succession at different azimuth angles θ, different elevations φ and different distances r from the transducer arrangement 1602 (shown by arrows in FIG. 16) and issues a test signal at each position.

A Dirac pulse may be transmitted as a test pulse, (e.g., a pulse of the shortest possible duration, and therefore containing the entire frequency spectrum). The impulse responses Iₙ(r, θ, φ) of each transducer n of the coincident transducer arrangement are shorted and provided with coordinates (r, θ, φ), which correspond to the position of the test sound source 1604 with reference to the transducer arrangement 1602. The measurements may be stored in a database in which each frequency response is determined by the parameters distance r, azimuth angle θ, elevation φ and transducer n.

In operation, through comparisons of the recorded time event with the stored impulse responses, each impulse response is filtered. In conditions in which there is an agreement or high similarity, the incident sound may be assigned special coordinates.

Analysis of the individual transducer signals may occur in block-oriented process. The microphone signals may be digitized by A/D (analog/digital) converters. When a predetermined number of samples are received, the sample may be combined into a block, of a predetermined block length. With each arriving sample, a block may be completed from a certain number of preceding samples. The decision algorithm or processor may be coordinated with the sampling frequency of the digital signal. In alternative systems, the decision algorithm or processor may track a time resolution that of video techniques with 25 fps (frames per second).

During comparison of the transducer signals with stored data, decisions may be based on similarities. A positive outcome may be identified when a sufficient agreement prevails. Positive outcomes are processed for localization of a sound source.

A block size is a gauge of the frequency resolution and therefore the quality of the decision. If the block length is too small, a decision or outcome may be in error. With increasing block length, the accuracy of the decision or outcome increases.

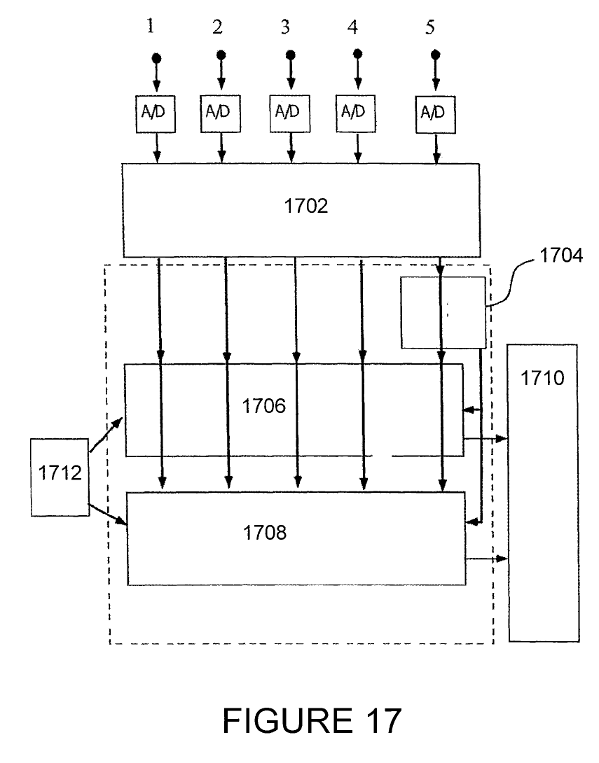

FIG. 17 is backend logic or a processor that processes an output arrangement including output gradient capsules 610, 620, 630, 1202 and an omni capsule 302 (corresponding to FIG. 12). The transducer output is converted to an analog/digital output and transmitted to block unit 1702. The area framed with a dashed line graphically shows some of programming that processes a signal or signal attributes.

A frequency analysis device 1704 is applied only to the omni signal of the pressure transducer 302, in this example. The frequency analysis unit analyzes the signal, so that the frequency components fᵢ, most strongly represented in the signal or having the highest levels, are identified.

The discrete frequencies fᵢ are divided into two groups. A lower frequency group FU includes frequencies f_{i,FU}, which are more strongly represented in the range from about 20 to about 1000 Hz, and an upper frequency group FO includes frequencies f_{i,FO}, that are most strongly represented in the range from about 1000 to 4000 Hz. The programmed limits may change with other applications. In many applications the frequencies f_{i,FO} of the upper frequency group FO are not influenced significantly by the near-field effect.

In a first act the direction of a sound source is identified. Depending on the transducer arrangement, just the azimuth (e.g., with 3 gradient transducers) or the azimuth angle and the elevation (e.g., with 4 gradient transducers) may be determined. The levels in the frequencies f_{i,FO} of the upper frequency group FO and information from the stored database may be processed. The datasets are stored in a local or a remote memory 1712. Since the near-field effect may have no significance for determination of the angle, only frequencies, in which the near-field effect is vanishingly small, are used for determination of the angle in many applications.

The transducer signals are divided into blocks and composed with the stored datasets to determine direction through the direction determination unit 1708. For each transducer signal, the spectrum of each block is formed, for example, by an FFT device (fast Fourier transformation). The frequency spectrum may be smoothed (for example, with a fixed one-third octave bandwidth), so that local minima do not distort the analysis.

For a predetermined number of individual discrete frequencies f_{i,FO} of frequency group FO, an angle determination occurs. The expression “angle” in this example is to be understood to be both the azimuth angle and the elevation, for the case of a flat angle determination (in only 2 or 3 gradient transducers) only the azimuth angle or only the elevation, accordingly.

The result, e.g., the angle found for frequency f_{i,FO}, is stored in the local or remote memory 1712 before the calculation for the next frequency point occurs. After the angle has been determined for several frequencies f_{i,FO}, a statistical estimate of the angle is found. If the frequency for a specific angle occurs. The system or process may identify a sound source and its corresponding direction. If the decision for this angle is correct, the process may estimate the distance r. The decisions are made by a controller or decision unit 1710, which communicates with the direction determination unit 1706.

If, a more or less equally distributed angle decision results, a system or process may determine the signal is noisy and a detection may not be detected for this block. The controller or decision unit 1710 may ignore the results of this block and carry over the parameters of the preceding block.

In some systems and processes, the comparison and determination of the angle may follow. A frequency f_{i,FO} is considered in the smooth frequency spectrum of a transducer block. The level at this frequency f_{i,FO} is designated Gₙ(f_{i,FO}) for gradient transducer n. Determination of the angle in the direction determination unit 1706 occurs through a comparison of the level ratios of the gradient transducer to the omni transducer for the transducer signals with the level ratios of the gradient transducer to the omni transducer for the stored datasets that were obtained from test measurements.

$$\begin{matrix}V ( {f}_{i , FO} ) = \frac{( \begin{matrix}{G}_{1} ( {f}_{i , FO} ) \\ {G}_{2} ( {f}_{i , FO} ) \\ {G}_{3} ( {f}_{i , FO} ) \\ {G}_{4} ( {f}_{i , FO} )\end{matrix} )}{K ( {f}_{i , FO} )} & ( 9 ) \\ {V}_{D} ( {f}_{i , FO} ) = \frac{( \begin{matrix}{I}_{1} ( {f}_{i , FO} ) \\ {I}_{2} ( {f}_{i , FO} ) \\ {I}_{3} ( {f}_{i , FO} ) \\ {I}_{4} ( {f}_{i , FO} )\end{matrix} )}{{I}_{K} ( {f}_{i , FO} )} & ( 10 )\end{matrix}$$

V(f_{i,FO}) is the ratio from the gradient transducer signal level Gₙ(f_{i,FO}) to the pressure transducer level K(f_{i, FO}) at a frequency f_{i, FO}.

V_{D}(f_{i,FO}) is the corresponding ratio obtained from the datasets of the database stored in memory 1712, in which Iₙ(f) is the frequency spectrum of the corresponding impulse response of a gradient transducer n and I_{K}(f) the frequency spectrum of the impulse response to the pressure transducer.

From the database, all ratios V_{D}(θ, φ, r, f) may be found and processed to determine direction. The dataset that has the strongest similarity with the ratio V(f), obtained from the transducers may be filtered out.

For each discrete frequency f_{i,FO}, the minimum for the following expression is found:

$$A ( {θ}_{min} , {ϕ}_{min} ) = {Min}_{θ , ϕ} {\sum }_{{r}_{m}} \vert {V}_{D}^{2} ( θ , ϕ , {r}_{m} , {f}_{i , FO} ) - {V}^{2} ( {f}_{i , FO} ) \vert \qquad ( 11 )$$

The square, V_{D}²−V², indicates that the minimum of the powers is of interest. The different distances rₘ, summed over different datasets, are then assigned. The power minimum A, found in the angles Azimuth θₘᵢₙ and elevation φₘᵢₙ, characterize it as the best agreement of the recorded signals with the stored datasets. This process continues for different frequencies f_{i,FO}. If the results give essentially the same angle, this angle is also classified by the controller decision unit 1710 as accurate. This process may be performed on each input block, so that the position determination is continuously updated, and moving sound sources may be tracked in a space.

If the direction is determined, the distance of the arrangement 1602 from the sound source may be estimated.

To determine the distance, the frequency spectra of the individual transducer blocks, smoothed in the direction determination unit 1706, are transmitted to the distance determination unit 1708. In contrast to angle determination, the curve trend at the lower frequencies f_{i,FU} of the lower frequency group FU is evaluated.

$$\begin{matrix}V ( {f}_{i , FU} ) = \frac{( \begin{matrix}{G}_{1} ( {f}_{i , FU} ) \\ {G}_{2} ( {f}_{i , FU} ) \\ {G}_{3} ( {f}_{i , FU} ) \\ {G}_{4} ( {f}_{i , FU} )\end{matrix} )}{K ( {f}_{i , FU} )} & ( 12 ) \\ {V}_{D} ( {f}_{i , FU} ) = \frac{( \begin{matrix}{I}_{1} ( {f}_{i , FU} ) \\ {I}_{2} ( {f}_{i , FU} ) \\ {I}_{3} ( {f}_{i , FU} ) \\ {I}_{4} ( {f}_{i , FU} )\end{matrix} )}{{I}_{K} ( {f}_{i , FU} )} & ( 13 )\end{matrix}$$

The frequencies f_{i,FU} designated in the formulas are prior frequencies selected by the frequency analysis unit 1704.

Since the near-field effect has a figure-eight like characteristic that gradient transducer may be used exclusively, for which the signal G or the ratio V is maximal. Vₘₐₓ will therefore be used exclusively to calculate the distance.

The minimum of the following expression gives the distance rₘᵢₙ

$$B ( {r}_{min} ) = {Min}_{r} \vert 1 - \frac{{\sum }_{{f}_{i , FU}} \frac{{V}_{max} ( {θ}_{min} , {ϕ}_{min} , r , {f}_{i , FU} )}{{V}_{D} ( {θ}_{min} , {ϕ}_{min} , r , {f}_{i , FU} )}}{numberFU} \vert \qquad ( 14 )$$

Vₘₐₓ then denotes the ratio from the gradient transducer signal spectrum with maximum level and the omni signal spectrum. The numberFU in formula (14) is the number of discrete frequency points f_{i,FU}, over which summation is carried out in the upper expression. The estimated value rₘᵢₙ, at which the expression B(r) becomes minimal, is then transferred to the controller or decision unit 1710 and the estimation completed from the angle and distance for this block.

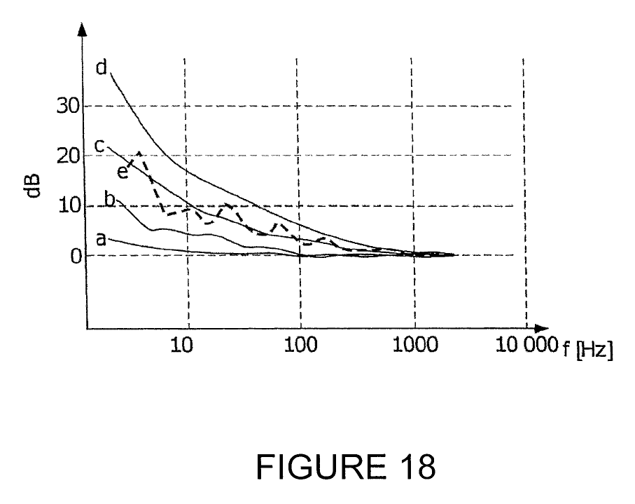

FIG. 18 shows an exemplary diagram, in which the ratio Vₘₐₓ(f) is shown as a function of frequency, in which the discrete frequencies f_{i,FU} are connected by a dashed line (curve e). The curves a, b, c and d correspond to datasets V_{D}(f) that are stored in memory 1712 and are compared according to formula (14) with Vₘₐₓ(f). In the present case, the lowest deviation to curve c is obtained and expression (14) becomes a minimum. Curve a then corresponds to large distance from the microphone arrangement, almost in the far-field. Curve d corresponds to a small distance, in which the near-field effect is strongly pronounced.

As described, the resolution, with reference to angle, depends on a minimal gradient transducer number and configuration. In the arrangement of FIG. 15, the positioning of the two gradient transducers, about 90° relative to each other, may result in some ambiguity in the interpretation of the level differences as a result of the near-field effect. Since the near-field effect has a figure-eight characteristic, two possible sound source positions may be found for direction and distance. The measured level distance, as a result of the near-field effect, occurs, on the one hand, for a sound source that exposes the gradient transducer 610 to sound at an angle of about 60° to the main direction. On the other hand, for a sound may expose the gradient transducer 610 to sound from about 180°. Gradient transducer 620, in these cases, should not be used, since both angles for gradient transducer 620 lie in a region close to about 90°, when the near-field effect is not present. To distinguish the sound source found at 60° or 180° phase may be processed. In this application, since the gradient transducers, up to the rejection maximum (at about 109° for hypercardioids), furnish the signal in phase, beyond that rejection angle the phase position is rotated by about 180°.

In addition to the alternative with 620 hypercardioids and a pressure transducer, the arrangement shown in FIG. 6 may be processed to determine azimuth and distance. Although a gradient microphone may not be in use, the sensitive phase position detection can be dispensed with and restriction to hypercardioids or hypercardioid-like pickup patterns can also drop out.

For detection of all three parameters, (e.g., distance, azimuth and elevation), at least three gradient transducers, orthogonal to each other, may be analyzed, as well as a pressure transducer, preferably positioned in the acoustic center.

Since this arrangement may be produced coincidentally, the arrangement of FIGS. 12 and 13 may be analyzed, since all spatial directions are covered and the pressure transducer 302 may be positioned in the center of the arrangement of gradient transducers.

If the position or direction of a sound source is determined, different acts may be initiated. For example, a camera may be controlled with the position data, so that it is continuously directed toward the sound source, for example, during a video conference. However, a microphone with controllable pickup pattern could be influenced, so that the useful sound source is preferably picked up by beam-forming device algorithms, while all other directions may be masked out.

Other alternate systems and methods may include combinations of some or all of the structure and functions described above or shown in one or more or each of the figures. These systems or methods are formed from any combination of structure and function described or illustrated within the figures. Some alternative systems or devices compliant with one or more of the transceiver protocols may communicate with one or more in-vehicle or out of vehicle receivers, devices or displays.

The methods and descriptions may be programmed in one or more controllers, devices, processors (e.g., signal processors). The processors may comprise one or more central processing units that supervise the sequence of micro-operations that execute the instruction code and data coming from memory (e.g., computer memory) that generate, support, and/or complete a compression or signal modifications. The dedicated applications may support and define the functions of the special purpose processor or general purpose processor that is customized by instruction code (and in some applications may be resident to vehicles). In some systems, a front-end processor may perform the complementary tasks of gathering data for a processor or program to work with, and for making the data and results available to other processors, controllers, or devices.

The methods and descriptions may also be programmed between one or more signal processors or may be encoded in a signal bearing storage medium a computer-readable medium, or may comprise logic stored in a memory that may be accessible through an interface and is executable by one or more processors. Some signal-bearing storage medium or computer-readable medium comprise a memory that is unitary or separate from a device, programmed within a device, such as one or more integrated circuits, or retained in memory and/or processed by a controller or a computer. If the descriptions or methods are performed by software, the software or logic may reside in a memory resident to or interfaced to one or more processors or controllers that may support a tangible or visual communication interface, wireless communication interface, or a wireless system.

The memory may include an ordered listing of executable instructions for implementing logical functions. A logical function may be implemented through digital circuitry, through source code, or through analog circuitry. The software may be embodied in any computer-readable medium or signal-bearing medium, for use by, or in connection with, an instruction executable system, apparatus, and device, resident to system that may maintain persistent or non-persistent connections. Such a system may include a computer-based system, a processor-containing system, or another system that includes an input and output interface that may communicate with a publicly accessible distributed network through a wireless or tangible communication bus through a public and/or proprietary protocol.

A “computer-readable storage medium,” “machine-readable medium,” “propagated-signal” medium, and/or “signal-bearing medium” may comprise any medium that contains stores, communicates, propagates, or transports software or data for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory, such as a Random Access Memory (RAM), a Read-Only Memory (ROM), an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A microphone arrangement comprising:
a plurality of pressure gradient transducers, each having a diaphragm, a first sound inlet opening leading to the front of the diaphragm, and a second sound inlet opening leading to the back of the diaphragm;
a directional characteristic of each pressure gradient transducer having a direction of maximum sensitivity in a main direction, and in which the main directions of the pressure gradient transducers are inclined relative to each other;
a pressure transducer having an acoustic center lying within an imaginary sphere with a plurality of acoustic centers of the pressure gradient transducers, the imaginary sphere having a radius corresponds to about double of the largest dimension of the diaphragm of the plurality of pressure gradient transducers or the pressure transducer;
a database that retains representative signals of the plurality of pressure gradient transducers and the pressure transducer; and
a processor that accessed the database to determine a position of a sound transmitting source.

2. The microphone arrangement of claim 1 where each of the acoustic centers of the pressure gradient transducers and the pressure transducer lie within an imaginary sphere whose radius corresponds to the largest dimension of the diaphragm of at least one of the plurality of pressure gradient transducer or the pressure transducer.

3. The microphone arrangement of claim 2 where the plurality of pressure gradient transducers comprises three pressure gradient transducers and where at least one of the three pressure gradient transducers is positioned such that the projections of the plurality of main directions main directions of the three pressure gradient transducers that lie in a base plane that is spanned by the first sound inlet openings of the pressure gradient transducers enclose an angle of substantially 120°.

4. The microphone arrangement of claim 1 where the plurality of pressure gradient transducers comprises three pressure gradient transducers and where at least one of the three pressure gradient transducers is positioned such that the projections of the plurality of main directions main directions of the three pressure gradient transducers that lie in a base plane that is spanned by the first sound inlet openings of the pressure gradient transducers enclose an angle of substantially 120°.

5. The microphone arrangement of claim 4 where the plurality of pressure gradient transducers and the pressure transducer are arranged within a boundary.

6. The microphone arrangement of claims 5 where of each of the pressure gradient transducers, the first sound inlet opening and the second sound inlet opening are arranged on a same side of a transducer housing.

7. The microphone arrangement of claims 1 where of each of the pressure gradient transducers, the first sound inlet opening and the second sound inlet opening are arranged on a same side of a transducer housing.

8. The microphone arrangement of claim 5, where each of the front surfaces of each of plurality of the pressure gradient transducers and the pressure transducer are arranged flush with a boundary.

9. The microphone arrangement of claim 1, where each of the front surfaces of each of plurality of the pressure gradient transducers and the pressure transducer are arranged flush with a boundary.

10. The microphone arrangement of claim 9 where the plurality of pressure gradient transducers, each of the first sound inlet openings is arranged on the front side of a transducer housing and each of the second sound inlet opening is arranged on a back side of the transducer housing.

11. The microphone arrangement of claim 1 where the plurality of pressure gradient transducers, each of the first sound inlet openings is arranged on the front side of a transducer housing and each of the second sound inlet opening is arranged on a back side of the transducer housing.

12. The microphone arrangement according to claim 11 where the plurality of pressure gradient transducers and the pressure transducer are arranged in a common capsule housing.

13. The microphone arrangement according to claim 1 where the plurality of pressure gradient transducers and the pressure transducer are arranged in a common capsule housing.

14. The microphone arrangement of claim 1 where the plurality of pressure gradient transducers comprises four pressure gradient transducers and at least one of the pressure transducer and the four pressure gradient transducers are arranged on surfaces of a tetrahedron.

15. The microphone arrangement of claim 2 where the plurality of pressure gradient transducers comprises four pressure gradient transducers and at least one of the pressure transducer and the four pressure gradient transducers are arranged on surfaces of a tetrahedron, and at least one pressure transducer is positioned within the tetrahedron.

16. The microphone arrangement of claim 15 further comprising a plurality of pressure transducers being arranged on the surfaces of or within the tetrahedron.

17. The microphone arrangement of claim 1 further comprising a plurality of pressure transducers arranged on a plurality of surfaces of a tetrahedron.

18. A method of synthesizing one or more microphone signals from a microphone arrangement comprising:
providing a plurality of pressure gradient transducers, each having a diaphragm, a first sound inlet opening leading to the front of the diaphragm, and a second sound inlet opening leading to the back of the diaphragm;
providing a directional characteristic of each of the plurality of pressure gradient transducer having a direction of maximum sensitivity in a plurality of main directions, and in which the plurality of main directions of the plurality of pressure gradient transducers are inclined relative to each other,
providing a pressure transducer having an acoustic center lying within an imaginary sphere with a plurality of acoustic centers of the pressure gradient transducers, the imaginary sphere having a radius corresponding to double the largest dimension of the diaphragm of the plurality of pressure gradient transducer or the pressure transducer;
providing a database that retains representative signals of a plurality of outputs of the pressure gradient transducers and the pressure transducer;
providing a processor that accessed the database to determine a position of a sound transmitting source; and
comparing outputs of the plurality of pressure gradient transducer and the pressure transducer; with a plurality of stored signals retained in the database, each stored signal corresponding to one of the outputs of the plurality of pressure gradient transducer and the pressure transducer and being coded with a position information in relation to a microphone arrangement;
where the determination of the position of the sound source depends on a similarity between the actual signal and the stored signal.

19. The method of claim 11 where outputs of the plurality of pressure gradient transducers and the pressure transducer comprise discrete frequency components that are selected and compared with corresponding discrete frequency components of the corresponding stored signal of the database.

20. The method of claim 19 where discrete frequency components of a high frequency region, in which the near field effect is negligible, are processed to determine the direction of the sound source.

21. The method of claim 18 where discrete frequency components of a high frequency region, in which the near field effect is negligible, are processed to determine the direction of the sound source.

22. The method of claim 21 where ratios between the outputs of the plurality of pressure gradient transducer signals and an output of pressure transducer signal at the discrete frequencies are compared with the corresponding ratios of the stored signals.

23. The method of claim 22 where the discrete frequency components of a low frequency region, in which the near field effect is not negligible, are processed to determine the distance of the sound source from a microphone arrangement.

23. The method of claim 18 where the discrete frequency components of a low frequency region, in which the near field effect is not negligible, are processed to determine the distance of the sound source from a microphone arrangement.

24. The method according to claim 23 where the ratios between the pressure gradient transducer signals and the pressure transducer signal at the discrete frequencies are compared with the corresponding ratios of the stored signals.

25. The method of claim 18 further comprising:
locating a test sound source is located at a plurality of positions in relation to the microphone arrangement;
transmitting a plurality of Dirac impulses;
recording the signals detected at that the signals recorded at each of the plurality of pressure gradient transducers and the pressure transducer by each transducer; and
storing the recoded signals with a code corresponding one of the plurality of pressure gradient transducers and the pressure transducer with an actual position of the test sound source in relation to the microphone arrangement.
